(19) United States
(12) Patent Application Publication
(10) Pub. No.: US 2013/0101242 A1
(43) Pub. Date: Apr. 25, 2013

(54) SEAL ARRANGEMENT

(71) Applicant: Wilhelm Sebald, Bad Konigshofen (DE)

(72) Inventor: Wilhelm Sebald, Bad Konigshofen (DE)

(73) Assignee: SCHAEFFLER TECHNOLOGIES AG & CO. KG, Herzogenaurach (DE)

(21) Appl. No.: 13/807,764

(22) PCT Filed: Jun. 27, 2011
(86) PCT No.: PCT/EP2011/060669

§ 371 Date: Dec. 31, 2012

(30) Foreign Application Priority Data
Jul. 1, 2010 (DE) 102010025803.2

(51) Int. Cl. F16C 33/76

(52) U.S. Cl. CPC F16C 33/76
USPC 384/91; 277/549

(57) ABSTRACT

A seal arrangement, in particular for sealing a thin section bearing. Specifically, the invention relates to a seal of a thin section bearing such as may be used for mounting a swashplate of a helicopter. According to the invention, this seal arrangement has at least two elastomer bodies, each of which form one radial sealing lip. A support body is arranged axially between the at least two elastomer bodies.

### FIELD OF THE INVENTION

The invention relates to a seal arrangement, in particular, for sealing a thin section bearing. Specifically, the invention relates to a seal of a thin section bearing such as may be used for mounting a swashplate of a helicopter.

### BACKGROUND

A swashplate of a helicopter is used to control an angle of attack of a rotor blade. It is typically mounted outside of a rotor mast and is formed of a non-rotating inner part and also an outer part rotating with rotor blades. These two parts are connected by a rolling bearing, often a thin section bearing constructed as a double-row angular contact ball bearing.

Thin section bearings are generally known and are characterized by a relatively small cross-sectional height, compared with a diameter, for example, with a diameter to cross-sectional height ratio of 10/1 to greater than 50/1.

Because such a swashplate rolling bearing has an exposed location, a seal against penetration of particles and moisture and a discharge of lubricant into or out of the swashplate rolling bearing is very important and a decisive feature for reliable use and also a long service life of the swashplate rolling bearing.

FIG. 5 and FIG. 6 show a typical seal according to the prior art for such a swashplate rolling bearing. FIG. 5 shows a double-row angular contact ball bearing that is sealed by a seal (FIG. 6) on each of its two axial sides primarily against the penetration of particles and moisture. Such a seal with a design as an axially sealing (single) lip seal with a radial lip, as shown in more detail in FIG. 6, has a disk-shaped support body on which an elastomer body is vulcanized. The elastomer body forms the one radial lip. The seal is arranged in a groove on an outer ring of the double-row angular contact ball bearing. The one radial lip of the seal forms a sliding contact on a sliding contact surface on an inner ring of the double-row angular contact ball bearing.

It has been shown for this type of seal that a (sealing) efficiency of the seal is limited due to temperature-related expansions and elastic twisting of the parts under loading.

Thus, swashplate rolling bearings that are sealed in such a way have proven disadvantageous especially due to the inadequate sealing function of the seals that are used, but also due to relatively frequent re-application of lubricant and/or short lubrication intervals, which thus makes high maintenance expenses necessary.

The service life of swashplate rolling bearings that are sealed in such a way can also be limited, sometimes significantly, due to damage resulting from particles that have penetrated into the swashplate rolling bearing.

### SUMMARY

In front of this backdrop, the object of the present invention is to provide a seal arrangement that fulfills the mentioned requirements for an effective seal, especially for swashplate thin section bearings, has a simple construction, and can be produced economically.

This object is met according to the invention by a seal arrangement according to the independent claim.

This seal arrangement has at least two elastomer bodies that each form a radial seal lip. A support body is arranged axially between the at least two elastomer bodies.

One essential advantage of the invention is that the sealing function is improved—especially due to the two radial lips—in a simple way for rolling bearings, wherein the entry of particles and/or moisture into a rolling bearing and/or the discharge of lubricant out of the rolling bearing is reduced. Thus the invention can counteract limitations in efficiency due to temperature-related expansions and elastic twisting of the parts under loading.

Thus, the service life of rolling bearings that are sealed in this way can be increased and/or lubrication intervals of rolling bearings that are sealed in this way can be shortened—and consequently costs can be reduced.

Especially for applications of sealed rolling bearings in environments in which down times/idle times—for example, down times for maintenance—cause high costs or bearing failures can lead to critical situations, i.e., with the possibility of bodily injury, for example, airplane or helicopter applications, the invention and its improved sealing function have proven to provide a great advantage.

In addition, the invention has proven advantageous in that seals according to the invention can be produced efficiently and economically using known technologies, for example, elastomer semi-finished parts with a plate shape.

Advantageous improvements of the invention are given from the dependent claims.

In one preferred improvement of the invention, the at least two elastomer bodies are constructed integrally. There can also be multiple elastomer bodies that each form a radial sealing lip and multiple support bodies, wherein here the multiple elastomer bodies that each form a radial lip can be constructed integrally. It can be further provided that a support body is arranged axially between every two of the multiple elastomer bodies.

It can also be preferably provided that the at least two elastomer bodies are formed from rubber, in particular, from nitrile rubber or from fluororubber.

In another construction it is provided that the support body has a higher stiffness than the at least two elastomer bodies. Thus, for example, the support body could be made from a material with a higher stiffness than the material of the elastomer bodies. The support body could be made from a metal or from a duroplastic, in particular, with textile and/or glass fiber reinforcement. The elastomer bodies could be made from rubber, in particular, from nitrile rubber or from fluororubber.

Furthermore, it could be preferably provided that the at least two elastomer bodies are connected to each other by bonding and/or vulcanization and/or the at least two elastomer bodies and the support body are connected to each other by bonding and/or vulcanization. Such production technologies are generally known and can be used economically, in particular, in the invention.

In another preferred improvement, it is provided that an axial side surface of the seal arrangement, in particular, of one of the at least two elastomer bodies, has one or more ring-shaped and/or point-shaped raised sections. This configuration can increase the axial elasticity of the seal arrangement and improve a seating of the seal arrangement in a mounting, for example, in a groove.

In an especially preferred way, the invention can be used for sealing a thin section bearing, in particular, a thin section bearing for mounting a swashplate of a helicopter. Here it is important if cost-intensive maintenance activities, such as re-lubrication and/or maintenance intervals, can be decreased or shortened. Also expensive down times/idle times—for example, down times for maintenance—can be reduced.

In another preferred improvement, a bearing system, in particular, a thin section bearing system, has at least one bearing ring and also the seal arrangement according to the invention, wherein the bearing ring has a groove or a recess in which the seal arrangement is inserted, centered, and/or held. It is especially advantageous if the at least one bearing ring is a static part of the bearing system, wherein the two sealing lips are in sliding contact with a part of the bearing system that can move relative to these lips.

It can also be provided in such a bearing system that at least one bearing ring or one seal runner connected to the bearing ring has at least one collar, in particular, a conical collar that is arranged at least partially axially between the at least two elastomer bodies.

A shape of the at least one conical collar, especially a width and/or taper, can be formed such that a contact pressure force that can be specified of the at least one conical collar against the radial sealing lips or the radial lips on the at least one conical collar can be achieved. The shape of the at least one conical collar, e.g., a conical collar tapered on one side, and/or the contact pressure force that is thus adjustable can also control or set a direction of the seal, i.e., a seal in one axial direction or in the opposite axial direction or in both axial directions—or in any combination. This arrangement thus can selectively reinforce counteractions against a penetration of particles into the bearing system or a discharge of lubricant out from the bearing system.

In another improvement it is provided that the bearing ring or a seal runner connected to the bearing ring has two or more collars, in particular, collars that are conical on one side (in cross section similar to a sawtooth profile), wherein a radial lip of the seal arrangement forms a contact on each side surface of the two or more collars, in particular, on a side surface that is inclined on one side of the two or more collars that are conical on one side.

### BRIEF DESCRIPTION OF THE DRAWINGS

Embodiments of the invention are described below with reference to figures. Shown therein are:

FIG. 1 a cross-section of a sealed, double-row angular contact ball bearing, for example, for the mounting of a swashplate of a helicopter, according to one embodiment of the invention,

FIG. 2 an axially sealing lip seal with two radial lips for the sealed, double-row angular contact ball bearing according to FIG. 1 (or FIG. 3),

FIG. 3 a cross-section of a sealed, double-row angular contact ball bearing with an axially sealing lip seal with two radial lips (double seal) according to another embodiment of the invention,

FIG. 4 a cross-section of a sealed, double-row angular contact ball bearing with an axially sealing lip seal with three radial lips (triple lip seal) according to another embodiment of the invention,

FIG. 5 a cross-section of a sealed, double-row angular contact ball bearing for the mounting of a swashplate of a helicopter according to the prior art, and

FIG. 6 an axially sealing (single) lip seal with a radial lip for the sealed, double-row angular contact ball bearing according to FIG. 5.

### DETAILED DESCRIPTION OF THE PREFERRED EMBODIMENTS

### Embodiment 1

### Double-Row Angular Contact Ball Bearing Sealed on Two Sides with Double Seal

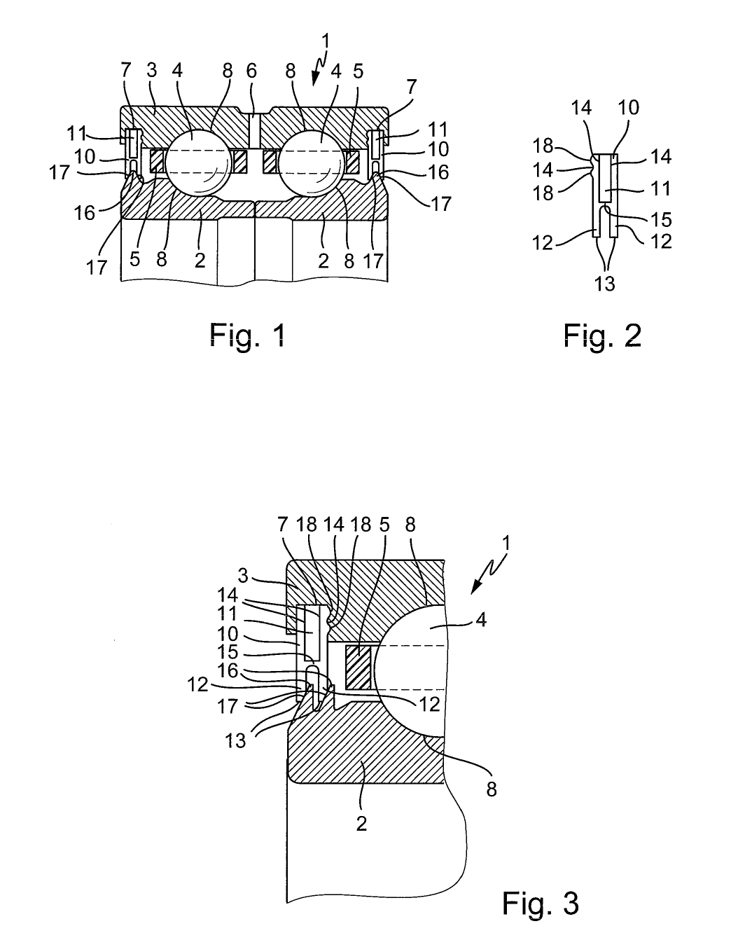

FIG. 1 shows a cross-section of a double-row angular contact ball bearing 1 that is sealed on two sides, like those used for mounting a swashplate of a helicopter.

The double-row angular contact ball bearing 1 that is sealed on two sides has an outer ring 3, a divided inner ring 2, and two rows of rolling bodies 4 or balls 4 that are all arranged between raceways 8 on the outer ring 3 or on the divided inner ring 2. The rolling bodies 4 of the two rows are all held by a cage 5. The outer ring 3 of this angular contact ball bearing 1 has a lubricating hole 6 in an area axially between the two raceways 8 of the outer ring 3.

In an area on each of the two axial ends of this angular contact ball bearing 1 there is an axially sealing lip seal 10 with two radial lips 13 (double seal). FIG. 2 shows this double seal 10 in more detail.

As FIG. 2 shows, this double seal 10 has a support body 11 that is made from a metal or from a duroplastic with textile or glass fiber reinforcement.

The support body 11 is surrounded on two axial sides 14 and one radial (bottom) side 15 by an elastomer 12, wherein the elastomer 12 and the support body 11 are connected to each other by vulcanization. The elastomer 12 is made from a synthetic nitrile rubber (NBR) or from a fluororubber (FKM) and thus has a lower stiffness than the support body 11.

In the radial direction, the elastomer 12 forms two radial projections 13, i.e., the two radial lips 13. The elastomer 12 has an integral construction here—as FIG. 2 shows—but two partial elastomers connected to each other are also conceivable, wherein each partial elastomer could form one of the two radial lips 13. Other partitions of the elastomer 12 into arbitrarily shaped partial elastomer bodies are also conceivable. A connection of partial elastomers into the overall body 12 or into the elastomer 12 could also be realized by vulcanization or by bonding.

As FIG. 2 further shows, on an (axial) side 14, the elastomer 12 has two ring-shaped raised sections that increase the axial elasticity of the double seal 10 and thus make the installation of the double seal 10 into the angular contact ball bearing 1 easier or reinforce the seating of the double seal 10 in a seal receptacle 7.

The two double seals 10 are each arranged in the axial end area of the angular contact ball bearing 1. For this purpose, the outer ring 3 of the angular contact ball bearing 1, i.e., in this case the static part of the angular contact ball bearing 1, has a groove 7 (seal receptacle) in each of the two axial end areas. The two double seals 10 are centered and held—improved by the ring-shaped raised section 18—in these grooves 7.

The inner ring 2 of the angular contact ball bearing 1 has, in the area of each of its axial ends, a conical rim or collar 16 that is directed radially outward, i.e., in the direction toward the outer ring 3. The two axial side surfaces of the conical collar 16—running together approximately symmetrically in the radial direction—form sliding contact surfaces 17 on which the two radial lips 13 of the double seal 10 press in the sliding contact.

Due to the geometry of the conical collar 16, i.e., among other things, the taper or the angle of incline, the direction of the taper and the diameter determine, among other things, the contact pressure force of the seal 10 that can be selected, for example, according to the application, and also the (axial) direction of the sealing effect.

As can be seen from FIG. 2, a sealing effect is realized in two axial directions by the contact of the two radial lips 13 on two sides of the conical collar 16. This prevents both a penetration of particles into the angular contact ball bearing 1 and also a discharge of lubricant out of the angular contact ball bearing.

### Embodiment 2

### Double-Row Angular Contact Ball Bearing that is Sealed on Two Sides with Double Seal, in Particular, Against the Penetration of Particles

FIG. 3 shows a cross-section of a double-row angular contact ball bearing 1 that is sealed on two sides with a double seal 10 similar to that according to FIG. 1 and FIG. 2 (embodiment 1) but with a somewhat modified sealing effect. The double seal 10 itself has an identical construction to that in FIG. 2 and FIG. 1.

Deviating from FIG. 1 or from the double-row angular contact ball bearing 1 that is sealed on two sides and is shown in FIG. 1, the angular contact ball bearing 1 has a modified inner ring 2 according to FIG. 3.

This modified inner ring 2 of the angular contact ball bearing 1 has, in the area of each of its axial ends, two conical collars or rims 16 that are tapered on one side and are directed radially outward, i.e., in the direction toward the outer ring 3. Only one axial side surface of each of these two one-sided, conical collars 16—in this case the side surface that is tapered on the conical collar 16 that is tapered on one side—forms the sliding contact surface 17 on which one of the two radial lips 13 of the double seal 10 presses in the sliding contact.

As can be seen from FIG. 3, a reinforced sealing effect in an axial direction is realized by the pressing of each of the two radial lips 13 on the corresponding (tapered) axial side surface of the two collars 16. As can be seen from FIG. 3, a sealing effect against the penetration of particles into the angular contact ball bearing 1 is reinforced here.

### Embodiment 3

### Double-Row Angular Contact Ball Bearing that is Sealed with Triple Lip Seal

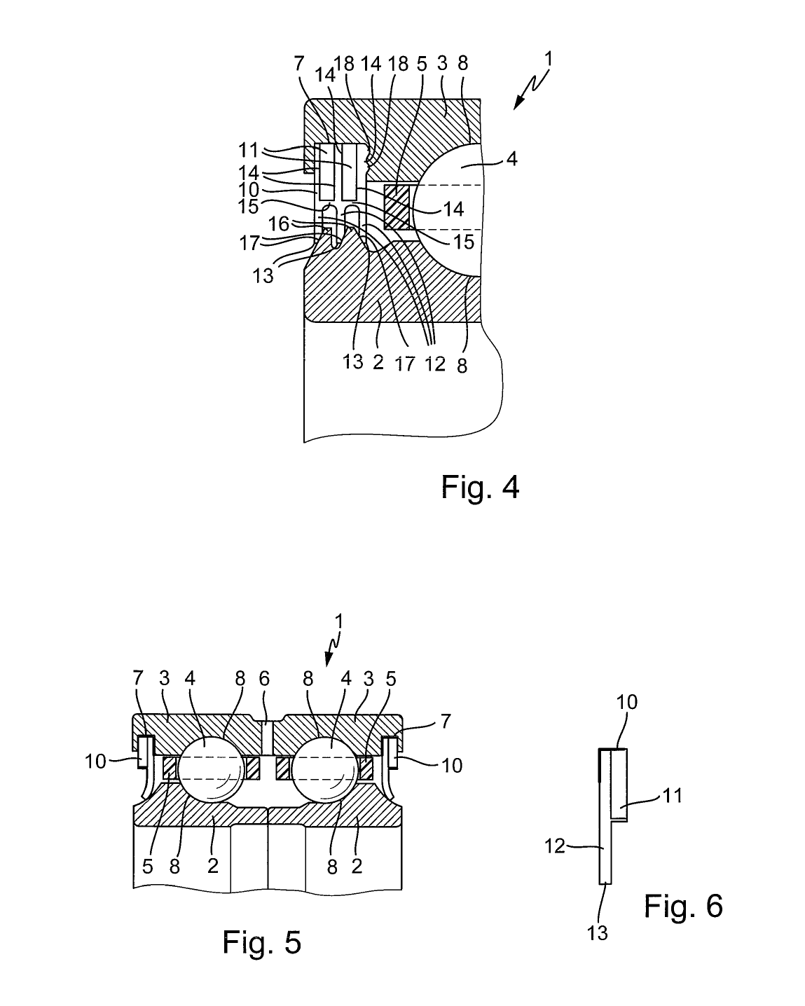

FIG. 4 shows a cross-section of another double-row angular contact ball bearing 1 that is sealed on two sides. This ball bearing is also constructed similar to that according to FIGS. 1 and 2 (embodiment 1) and FIG. 3 (embodiment 2).

Deviations from the described angular contact ball bearings 1 according to FIGS. 1 to 3 lie in the construction according to FIG. 4 in the type of seal, i.e., triple lip seal 10 according to FIG. 4, and also another inner ring 2—modified accordingly or adapted to the triple lip seal 10—in the angular contact ball bearing 1.

This further modified inner ring 2 of the angular contact ball bearing 1 has, in the area of each of its axial ends, two conical collars 13 that are directed radially outward, i.e., in the direction toward the outer ring 3. The first collar 13 lying farther outside in the axial direction of the two collars 13 has a conical shape that is tapered on one side, while the second collar 13 lying farther inside in the axial direction of the two collars 13 has a conical shape that is tapered on two sides.

As FIG. 4 further shows, this triple lip seal 10 has two support bodies 11 that are each formed from a metal or from a duroplastic with textile or glass fiber reinforcement.

The two support bodies 11 are enclosed on each of two axial sides 14 and the radial (bottom) side 15 by an elastomer 12, wherein the elastomer 12 and the support body 11 are connected to each other by vulcanization. The elastomer 12 is made from a synthetic nitrile rubber (NBR) or from a fluororubber (FKM) and thus has a lower stiffness than the support bodies 11.

In the radial direction, the elastomer 12 forms three radial projections 13, i.e., the three radial lips 13 of the triple lip seal 10. The elastomer 12 is also formed integrally here—as FIG. 4 shows—but multiple partial elastomers that are connected to each other and that could each form one of the three radial lips 13 are also conceivable here. A connection of partial elastomers to form the overall body 12 or the elastomer 12 could also be realized by vulcanization or by bonding.

As FIG. 4 further shows, the elastomer 12 also has, on an (axial) side 14, two ring-shaped raised sections 18 that increase the axial elasticity of the double seal 10 and thus make the installation of the triple lip seal 10 into the angular contact ball bearing 1 easier or reinforce the seating of the triple lip seal 10 in the groove 7.

Here, the tapered side surfaces of the two conical collars 16 also form the sliding contact surfaces 17 on which the three radial lips 13 of the triple lip seal 10 press in the sliding contact.

As can be seen from FIG. 4, a radial lip 13 of the triple lip seal 10 contacts the “only” tapered axial side of the first collar 16; the other two radial lips 13 of the triple lip seal 10 contact the two tapered axial side surfaces of the second collar 16.

Here, a sealing effect against the penetration of particles into the angular contact ball bearing 1 is also reinforced—with a simultaneously high sealing effect against the discharge of lubricant.

### REFERENCE NUMBERS

1 Rolling bearing arrangement, sealed, double-row angular contact ball bearing
2 Inner ring or divided inner ring
3 Outer ring
4 Rolling body, ball
5 Cage
6 Hole, lubricating hole
7 (Mounting) groove (on the outer ring)
8 Raceway
10 Lip seal
11 Support body
12 Elastomer, elastomer body
13 Radial lip
14 (Axial) side surface
15 Radial (bottom) side
16 Rim (on the inner ring)
17 Sliding contact surface
18 Raised sections, in particular, point-shaped or ring-shaped, on the lip seal 10 or the elastomer body 12

1. Seal arrangement comprising at least two elastomer bodies that each form a radial sealing lip, and a support body is arranged axially between the at least two elastomer bodies.

2. Seal arrangement according to claim 1, wherein the at least two elastomer bodies are formed integrally.

3. Seal arrangement according to claim 1, wherein the support body has a higher stiffness than the at least two elastomer bodies.

4. Seal arrangement according to claim 1, wherein the support body is made from a metal or from a duroplastic.

5. Seal arrangement according to claim 1, wherein the at least two elastomer bodies are connected to each other by at least one of bonding or vulcanization.

6. Seal arrangement according to claim 1, wherein an axial side surface of the seal arrangement has one or more ring-shaped or point-shaped raised sections.

7. Seal arrangement according to claim 1, wherein there are multiple elastomer bodies that each form a radial sealing lip and multiple support bodies.

8. Seal arrangement according to claim 1, wherein the seal arrangement is used as a seal for a thin section bearing.

9. A bearing system with at least one bearing ring and one seal arrangement according to claim 1, wherein the bearing ring has a groove or a recess in which the seal arrangement is inserted.

10. A bearing system with at least one bearing ring and one seal arrangement according to claim 1, wherein the bearing ring or a seal runner connected to the bearing ring has at least one collar that is arranged at least partially axially between the at least two elastomer bodies.

11. The bearing system according to claim 10, wherein the at least one collar is conical, and at least one of a width or taper is formed such that a contact pressure force that can be specified of the at least one conical collar against radial sealing lips or radial lips formed by the elastomer bodies can be achieved or a seal can be achieved in one or two axial directions.

12. The bearing system according to claim 10, wherein the bearing ring or the seal runner connected to the bearing ring has two or more collars, and a radial lip of the seal arrangement forms a contact on each side surface of the two or more collars.

13. The bearing arrangement according to claim 12, wherein the collars are conical on one side, and the radial lip of the seal arrangement forms a contact on the side surfaces that are tapered on the two or more collars that are conical on one side.

14. Seal arrangement according to claim 1, wherein the at least two elastomer bodies are formed from rubber.

15. Seal arrangement according to claim 4, wherein the support body is made from duroplastic with a textite or glass fiber reinforcement.

16. Seal arrangement according to claim 1, wherein the at least two elastomer bodies and the support body are connected to each other by at least one of bonding or vulcanization.

17. Seal arrangement according to claim 7, wherein one of the support bodies is arranged axially between every two of the elastomer bodies.
